(19) United States
(12) Patent Application Publication
(10) Pub. No.: US 2026/0126740 A1
(43) Pub. Date: May 7, 2026

(54) IMAGE FORMING APPARATUS

(71) Applicant: CANON KABUSHIKI KAISHA, Tokyo (JP)

(72) Inventors: Shinsuke Kobayashi, Kanagawa (JP); Akimichi Suzuki, Kanagawa (JP); Masashi Tanaka, Kanagawa (JP); Hikaru Osada, Kanagawa (JP); Jun Hara, Tokyo (JP); Akisato Sakaki, Kanagawa (JP)

(21) Appl. No.: 19/372,407

(22) Filed: Oct. 29, 2025

(30) Foreign Application Priority Data
Nov. 6, 2024 (JP) 2024-194553

(51) Int. Cl. G03G 15/08

(52) U.S. Cl. CPC G03G 15/0862; G03G 15/0865; G03G 15/0891; G03G 2215/0827; G03G 2215/0891

(57) ABSTRACT

In an image forming apparatus, a developing roller accommodating unit includes a developing roller and has an opening of a length smaller than a length of the developing roller in a direction of a rotation axis of the developing roller. A replenishment operation determination unit determines to perform a replenishment operation if a predetermined condition is satisfied. A pixel number determination unit determines, based on information on a number of pixels in an image to be formed, a number of pixels in both a first area and a second area obtained by dividing an image formation area. The predetermined condition is at least one of that the first number of pixels in the first area is greater than a first threshold and that the second number of pixels in the second area is greater than a second threshold different from the first threshold.

### BACKGROUND

### Field of the Technology

The present disclosure relates to an image forming apparatus.

### Description of the Related Art

In an electrophotographic image forming apparatus, to prevent density unevenness from arising in a toner image formed by developing an electrostatic latent image using toner, the toner is supplied uniformly to the entirety of a developing member (a developing roller). Japanese Patent Laid-Open No. 2010-66582 discloses a configuration in which the rotation speed of a toner conveyance member is controlled on the basis of a result of detecting toner density in order to supply toner to a developing member uniformly.

### SUMMARY

However, with this past technique, if a replenishment opening is provided in a partial area in the lengthwise direction of the developing container, an image with blank patches may arise due to insufficient toner being supplied to the developing member.

The present disclosure reduces the occurrence of images having blank patches in an image forming apparatus in which a replenishment opening is provided in a partial area in the lengthwise direction of a developing container (a developing roller accommodating unit).

According to one aspect of the present disclosure, there is provided an image forming apparatus comprising: a developing agent accommodating unit configured to accommodate a developing agent; a developing roller accommodating unit including a developing roller that develops an electrostatic latent image formed on a photosensitive member, and having an opening of a length smaller than a length of the developing roller in a direction of an axis of rotation of the developing roller, the developing roller accommodating unit configured to accommodate the developing agent supplied from the developing agent accommodating unit through the opening; an image formation control unit configured to receive a print job including information on a number of pixels in an image to be formed on a recording material and execute an image formation operation based on the print job; a replenishment operation determination unit configured to determine to perform a replenishment operation in a case where a predetermined condition is satisfied, the replenishment operation being an operation of supplying the developing agent from the developing agent accommodating unit to the developing roller accommodating unit; and a pixel number determination unit configured to determine, based on the information, a number of pixels in both a first area and a second area, each being a part of an image formation area of the recording material and being obtained by dividing the image formation area in the direction of the axis of rotation, wherein in a case where the number of pixels in the first area determined by the pixel number determination unit is taken as a first number of pixels and the number of pixels in the second area determined by the pixel number determination unit is taken as a second number of pixels, the predetermined condition is at least one of that the first number of pixels is greater than a first threshold and that the second number of pixels is greater than a second threshold different from the first threshold.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view illustrating an example of the hardware configuration of an image forming apparatus.

FIGS. 2A and 2B illustrate an example of a standby orientation and a replenishment orientation of a rotary body.

FIG. 3 illustrates an example of the motor configuration of the image forming apparatus.

FIG. 4A is a cross-sectional view illustrating an example of the configuration of a toner cartridge and a developing unit.

FIG. 4B illustrates an example of the arrangement of a replenishment opening.

FIGS. 5A and 5B illustrate examples of toner states within the developing unit.

FIG. 6 is a block diagram illustrating an example of the control configuration of the image forming apparatus.

FIGS. 7A to 7C illustrate an example of a method for dividing an image area.

FIGS. 8A to 8C illustrate an example of the arrangement of replenishment openings (a second embodiment).

FIGS. 9A and 9B illustrate an example of a method for dividing an image area (the second embodiment).

FIG. 10 is a cross-sectional view illustrating an example of the hardware configuration of an image forming apparatus (a third embodiment).

FIG. 11 is a cross-sectional view illustrating an example of the configuration of a developing device (the third embodiment).

FIGS. 12A and 12B illustrate examples of toner states within the developing unit (the third embodiment).

FIG. 13 illustrates an example of a method for dividing an image area (the third embodiment).

FIG. 14 is a flowchart illustrating an example of a processing sequence for toner replenishment control.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming Apparatus

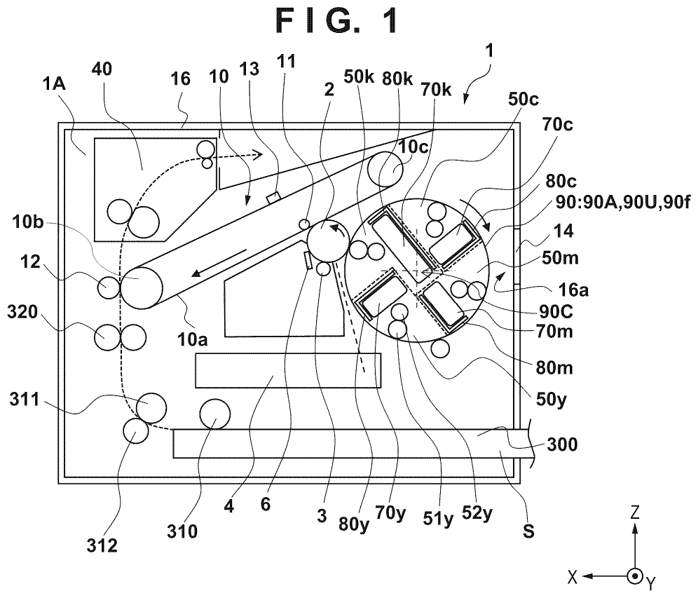

FIG. 1 is a cross-sectional view schematically illustrating an example of the hardware configuration of an image forming apparatus 1 according to a first embodiment. In the following descriptions and in each of the drawings, the vertical direction when the image forming apparatus 1 is installed on a horizontal surface is taken as the Z direction. A direction of a rotation axis 90C of a rotary body 90 (described later; the rotary axis direction), which intersects the Z direction, is taken as the Y direction. A direction that intersects both the Z direction and the Y direction is taken as the X direction. The X direction and the Y direction are preferably horizontal directions. The X direction, the Y direction, and the Z direction are preferably orthogonal to each other. The directions of the arrows X, Y, and Z in the drawings are represented as +X, +Y, and +Z, respectively, and the sides opposite therefrom are indicated by −X, −Y, and −Z, respectively, as necessary. Note that in the present embodiment, Y is the lengthwise direction.

The image forming apparatus 1 is a color laser beam printer including four developing units 50y, 50m, 50c, and 50k (developing containers or developing roller accommodating units). Paper such as plain paper or heavy paper, and various types of sheet materials having different sizes and made of different materials, can be used as a sheet S, which is a recording material (a recording medium). In the following descriptions, the subscripts y, m, c, and k appended to each reference sign indicate that the color of the developing agent (toner) for the component in question is yellow, magenta, cyan, or black. The basic structures and functions of the developing units 50y, 50m, 50c, and 50k are the same. The basic structures and functions of toner cartridges 70y, 70m, 70c, and 70k are also the same. Furthermore, the basic structures and functions of trays 80y, 80m, 80c, and 80k are the same. Accordingly, when there is no need to distinguish between the four units, cartridges, or trays, the subscripts y, m, c, and k will be omitted and the component in question will be described as a single component.

As illustrated in FIG. 1, the image forming apparatus 1 includes an apparatus main body 1A and the toner cartridges 70y, 70m, 70c, and 70k, which are removable from the apparatus main body 1A. The apparatus main body 1A of the present embodiment is a part excluding the toner cartridges 70y, 70m, 70c, and 70k from the image forming apparatus 1. The toner cartridges 70y, 70m, 70c, and 70k are examples of developing agent accommodating units (toner containers) that accommodate a developing agent (toner).

The apparatus main body 1A includes an electrophotographic photosensitive member (“photosensitive drum”) 2 having a drum shape (a cylindrical shape) as an image carrier that carries an electrostatic latent image. A charging roller 3, a scanner 4 serving as an exposure device, and a cleaning unit 6 are disposed in the periphery of the photosensitive drum 2. The charging roller 3 uniformly charges the photosensitive drum 2. The scanner 4 performs exposure by irradiating the photosensitive drum 2 with laser light based on image information (input image data). An electrostatic latent image is formed on the photosensitive drum 2 (on the photosensitive member) by irradiating the charged photosensitive drum 2 with laser light from the scanner 4. The cleaning unit 6 removes toner remaining on the surface of the photosensitive drum 2.

The apparatus main body 1A further includes a sheet accommodating unit 300, a pickup roller 310, a feed roller 311, a separation roller 312, a conveyance roller pair 320, a secondary transfer roller 12, a fixing device 40, and an intermediate transfer unit 10. The pickup roller 310 feeds the sheet S into a conveyance path. The feed roller 311 and the separation roller 312 constitute a sheet separation unit that separates and conveys the sheets S one by one using frictional force. The secondary transfer roller 12 transfers an image (a toner image) from an intermediate transfer belt 10a to the sheet S.

The intermediate transfer unit 10 (an intermediate transfer body) includes the intermediate transfer belt 10a, a belt driving roller 10b, a tension roller 10c, a cleaning device 13, and a primary transfer roller 11. The intermediate transfer belt 10a carries the image transferred from the photosensitive drum 2 (a primary transfer) and conveys the image for transfer onto the sheet S (a secondary transfer). The intermediate transfer belt 10a is stretched over the belt driving roller 10b and the tension roller 10c. The belt driving roller 10b is a driving member that moves the intermediate transfer belt 10a by being rotationally driven by a drive source.

The apparatus main body 1A includes a rotary main body (a rotary; a rotating body) 90 including the developing units 50y, 50m, 50c, and 50k (developing roller accommodating units). As will be described later, in the present embodiment, the trays 80y, 80m, 80c, and 80k are attached to the rotary body 90. The toner cartridges 70y, 70m, 70c, and 70k are removably attached to the trays 80y, 80m, 80c, and 80k, respectively.

The developing units 50y, 50m, 50c, and 50k develop (visualize) the electrostatic latent image formed on the photosensitive drum 2 into a toner image using the toner (developing agent) of the corresponding color. Specifically, the developing units 50y, 50m, 50c, and 50k develop the electrostatic latent image formed on the photosensitive drum 2 using yellow toner, magenta toner, cyan toner, and black toner, respectively.

The developing unit 50y includes a developing roller 51y, a supply roller 52y, and a developing blade. The developing roller 51y is a developing agent carrier that carries toner as a developing agent, rotates, and supplies the toner to the photosensitive drum 2. The supply roller 52y is a supply member that is disposed in contact with the developing roller 51y and supplies toner to the developing roller 51y. The developing blade is a regulating member that regulates the thickness of a toner layer carried by the developing roller 51y. Like the developing unit 50y, the other developing units 50m, 50c, and 50k are also equipped with developing rollers 51m, 51c, and 51k, supply rollers 52m, 52c, and 52k, and developing blades, respectively.

The toner cartridges 70y, 70m, 70c, and 70k corresponding to the developing units 50y, 50m, 50c, and 50k, respectively, are attached to the rotary body 90. The toner cartridges 70y, 70m, 70c, and 70k contain yellow toner, magenta toner, cyan toner, and black toner as toners for replenishing the developing units 50y, 50m, 50c, and 50k, respectively.

The rotary body 90 includes a rotary frame 90f that supports the developing units 50y, 50m, 50c, and 50k. The rotary frame 90f is a rotational support member capable of rotating. Herein, the rotary body 90 and the parts of the trays 80y, 80m, 80c, and 80k attached to the rotary body 90 will be referred to as a “rotary unit 90U”. In other words, the rotary unit 90U includes the rotary body 90 and the trays 80y, 80m, 80c, and 80k.

As described above, the toner cartridges 70y, 70m, 70c, and 70k are removably held by the trays 80y, 80m, 80c, and 80k, respectively. The trays 80y, 80m, 80c, and 80k are supported so as to be capable of sliding to the outside of the rotary body 90. Herein, the portion that combines the rotary unit 90U and the toner cartridges 70y, 70m, 70c, and 70k will be referred to as a “rotary assembly 90A”. In other words, the rotary assembly 90A includes the rotary unit 90U and the toner cartridges 70y, 70m, 70c, and 70k.

The rotary body 90 is configured to be capable of rotating about the rotation axis (rotational center) 90C. The rotation axis 90C coincides with a rotation axis of the rotary frame 90f, the rotary unit 90U, and the rotary assembly 90A. The rotation axis 90C is substantially parallel to the rotation axis (rotational center) of the photosensitive drum 2.

By rotating about the rotation axis 90C, the rotary body 90 can assume a developing orientation, which is an orientation in which any one of the developing rollers 51y, 51m, 51c, and 51k is opposed to the photosensitive drum 2. The orientation in which the developing roller 51y opposes the photosensitive drum 2 is called a “yellow developing orientation”. The orientation in which the developing roller 51m opposes the photosensitive drum 2 is called a “magenta developing orientation”. The orientation in which the developing roller 51c opposes the photosensitive drum 2 is called a “cyan developing orientation”. The orientation in which the developing roller 51k opposes the photosensitive drum 2 is called a “black developing orientation”. In this manner, the rotary body 90 is configured to rotate about the rotation axis 90C such that the positions of the developing rollers 51y, 51m, 51c, and 51k relative to the photosensitive drum 2 change.

The image forming apparatus 1 of the present embodiment has a color mode, in which a color image (a multicolor image) is formed on the sheet S, and a monochromatic mode, in which a monochromatic image (a single-color image) is formed on the sheet S, as operation modes for image forming.

In the image forming apparatus 1, the image forming process in the color mode is executed as follows. When a yellow toner image is developed (formed) on the photosensitive drum 2, the toner image on the photosensitive drum 2 undergoes a primary transfer to the intermediate transfer belt 10a by the primary transfer roller 11 disposed on the inner side of the intermediate transfer belt 10a. Then, by rotating the rotary body 90 and moving the developing rollers 51m, 51c, and 51k to developing positions in order, the toner images of the corresponding colors are formed on the photosensitive drum 2 in that order. As described above, after the yellow toner image is formed on the intermediate transfer belt 10a, the rotary body 90 assumes the magenta developing orientation, and the magenta toner image is formed on the intermediate transfer belt 10a. After the magenta toner image is formed on the intermediate transfer belt 10a, the rotary body 90 assumes the cyan developing orientation, and the cyan toner image is formed on the intermediate transfer belt 10a. After the cyan toner image is formed on the intermediate transfer belt 10a, the rotary body 90 assumes the black developing orientation, and the black toner image is formed on the intermediate transfer belt 10a.

In this manner, the four color toner images undergo a primary transfer from the photosensitive drum 2 to the intermediate transfer belt 10a in order. At that time, a color image is formed on the intermediate transfer belt 10a by repeating the primary transfer such that the four color toner images are superimposed on the intermediate transfer belt 10a. Note that the secondary transfer roller 12 and the cleaning device 13 are not in contact with the intermediate transfer belt 10a until the color image is formed on the intermediate transfer belt 10a.

Meanwhile, the sheet S is fed to the conveyance path by the pickup roller 310 from the sheet accommodating unit 300 provided in a lower part of the apparatus main body 1A. The sheets S are conveyed along the conveyance path to the conveyance roller pair 320 having been separated one by one by the feed roller 311 and the separation roller 312. The conveyance roller pair 320 sends the sheet S conveyed through the conveyance path from the sheet accommodating unit 300 to a transfer part (a secondary transfer part), which is a nip part between the intermediate transfer belt 10a and the secondary transfer roller 12. At the secondary transfer part, the color image on the intermediate transfer belt 10a is transferred onto the surface of the sheet S that has been conveyed (the secondary transfer).

The sheet S onto which the color image has been transferred is conveyed to the fixing device 40. In the fixing device 40, the sheet S is heated and pressurized, and the image is fixed to the sheet S. The sheet S that has passed through the fixing device 40 is discharged to the exterior of the image forming apparatus 1 as a finished product.

In the image forming apparatus 1, the image forming process in the monochromatic mode is executed as follows. First, the developing roller 51k is positioned in the developing position by the rotary body 90 assuming the black developing orientation. In this state, after the electrostatic latent image is formed on the surface of the photosensitive drum 2 by charging and exposing the photosensitive drum 2, the electrostatic latent image is developed using black toner by the developing roller 51k at the developing position. The black toner image formed on the photosensitive drum 2 undergoes the primary transfer to the intermediate transfer belt 10a, and then undergoes the secondary transfer to the sheet S. The steps that follow thereafter are the same as those taken when forming a color image.

In the monochromatic mode, of the developing units 50y, 50m, 50c, and 50k, only the developing unit 50k corresponding to black toner is used for the image forming. Accordingly, when forming images on a plurality of sheets in monochromatic mode, images can be formed continuously on the plurality of sheets while keeping the rotary body 90 in the black developing orientation, without rotating the rotary body 90 every time the formation of an image on a single sheet is complete.

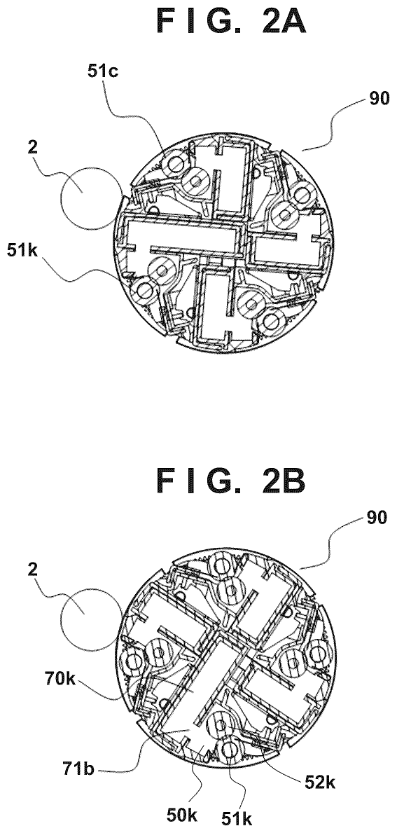

By rotating about the rotation axis 90C, the rotary body 90 can also assume an orientation in which the developing rollers 51y, 51m, 51c, and 51k are not opposite to the photosensitive drum 2. As illustrated in FIG. 2A, in the present embodiment, a state in which the photosensitive drum 2 is positioned between the developing roller 51c and the developing roller 51k, and the developing rollers 51 and the photosensitive drum 2 are distanced from each other, is set as a standby orientation. The image forming apparatus 1 stops the rotary body 90 such that the rotary body 90 assumes this standby orientation while the rotary body 90 is standing by, without image formation being performed.

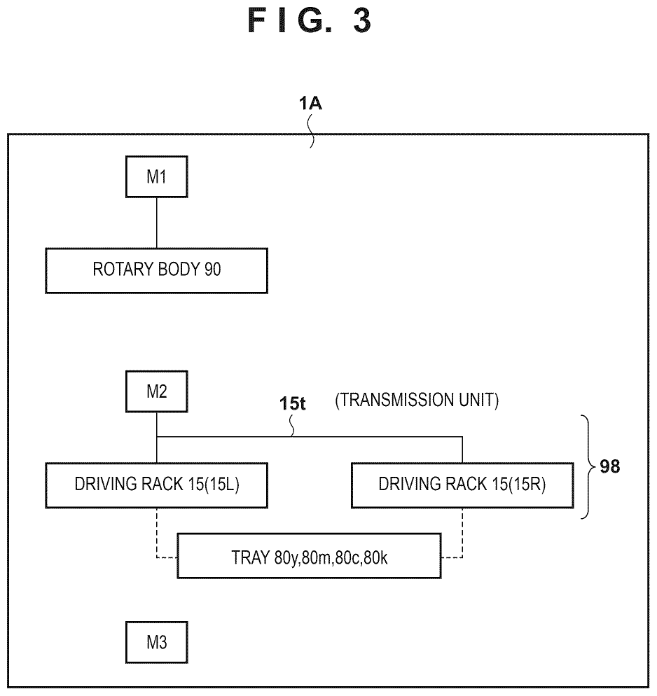

FIG. 3 is a diagram illustrating an example of the motor configuration of the image forming apparatus 1 of the present embodiment. As illustrated in FIG. 3, the apparatus main body 1A includes motors M1, M2, and M3 as drive sources for driving the components within the image forming apparatus 1. The motor M1 supplies drive force for rotating the rotary body 90 about the rotation axis 90C. The rotary assembly 90A and the rotary unit 90U rotate about the rotation axis 90C as a result.

The apparatus main body 1A also has a drive device 98 including a motor M2 and a transmission device. The transmission device includes drive racks 15L and 15R as drive gears, and a transmission unit 15t. Drive force from the motor M2 is transmitted to the drive racks 15L and 15R by the transmission unit 15t. The trays 80y, 80m, 80c, and 80k move relative to the rotary body 90 through the drive racks 15L and 15R as a result.

The motor M3 drives the components other than the components driven by the motor M1 and the motor M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40. Note that the components driven by the motors M1, M2, and M3 may be changed from the examples described above. Additionally, any two or all three roles of the motors M1, M2, and M3 may be consolidated in a single motor. Alternatively, drive sources other than the motors M1, M2, and M3 may be added.

### 2. Toner Cartridge and Developing Unit

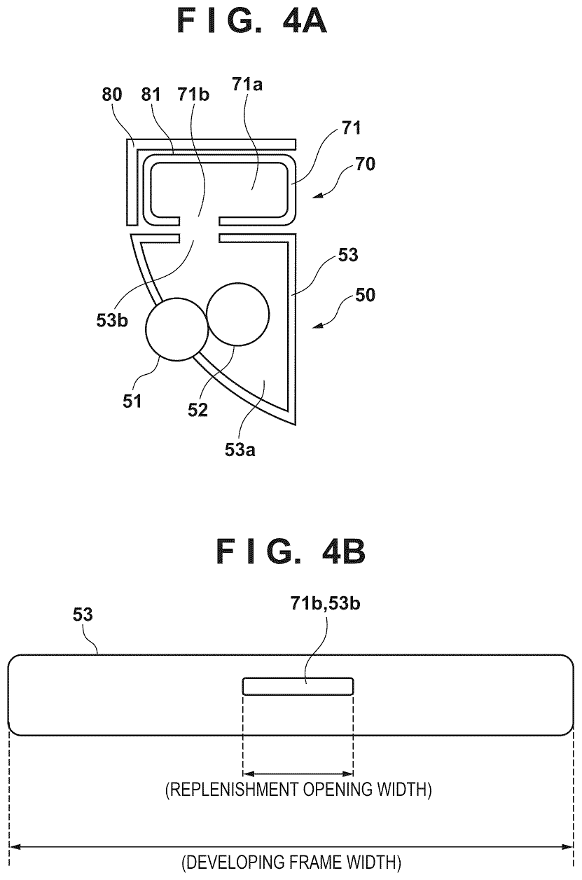

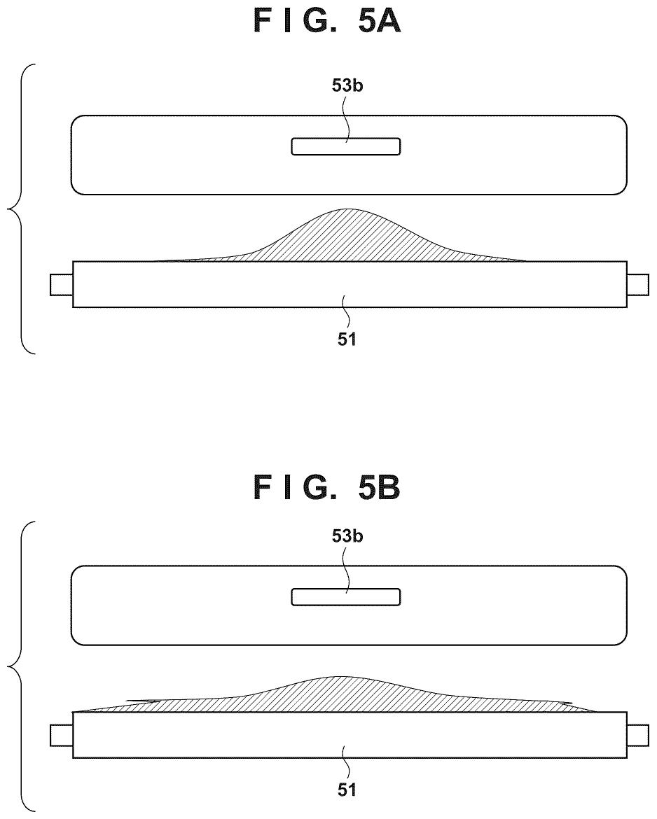

FIG. 4A is a cross-sectional view illustrating an example of the configuration of the toner cartridge 70 and the developing unit 50. As illustrated in FIG. 2, the toner cartridge 70 has a toner frame 71. The toner frame 71 includes a toner accommodating unit 71a that accommodates toner, and a discharge opening 71b that communicates with the toner accommodating unit 71a.

The developing unit 50 includes a developing frame (a accommodating frame) 53. The developing frame 53 includes a developing-side accommodating unit 53a, and a receiving opening 53b constituting a replenishment opening that communicates with the developing-side accommodating unit (a toner supply chamber) 53a. The developing unit 50 includes the developing roller 51, the supply roller 52, and the like.

Relative to the developing frame 53, the toner cartridge 70 can move between a mounted position and a retracted position, in which the toner cartridge 70 is retracted from the mounted position. When the toner cartridge 70 is in the mounted position relative to the developing frame 53, the discharge opening 71b is opposite the receiving opening 53b. In other words, the toner accommodating unit 71a of the toner cartridge 70 and the developing-side accommodating unit 53a of the developing unit 50 communicate through the discharge opening 71b and the receiving opening 53b. When the developing unit 50 is replenished with toner from the toner cartridge 70, at least a part of the receiving opening 53b is positioned below at least a part of the discharge opening 71b.

FIG. 4B illustrates an example of the arrangement of the replenishment opening, which is in a communication position where the discharge opening 71b of the toner cartridge 70 communicates with the receiving opening 53b of the developing unit 50, and illustrates an example of the arrangement with respect to the developing frame 53 (the developing unit 50) when viewed from above. As illustrated in FIG. 4B, the width of the replenishment opening (a replenishment opening width) is shorter than the length of the developing frame 53 in the direction parallel to the axis of rotation of the developing roller 51 (a developing frame width). This is to prevent the toner from clogging in the developing unit 50 and toner leakage from the replenishment opening (in the communication position) due to the developing unit 50 being replenished with too much toner at once from the toner cartridge 70. Accordingly, it is desirable for the width of the replenishment opening to be set (to a smaller width) such that the developing unit 50 is replenished with toner from the toner cartridge 70 little by little. As one example, in the present embodiment, the width of the replenishment opening in the widthwise direction is set to be no greater than ⅓ the width of the developing unit 50 in the widthwise direction.

In this manner, in the developing unit 50 (the developing roller accommodating unit), the receiving opening 53b is formed as an opening having a length that is smaller (shorter) than the length of the developing roller 51 in the direction of the axis of rotation of the developing roller 51. The developing unit 50 (the developing roller accommodating unit) is configured to hold toner (the developing agent) supplied from the toner cartridge 70 (the developing agent accommodating unit) through the receiving opening 53b for development by the developing roller 51.

Although not illustrated, it is desirable for the toner cartridge 70 to have a sealing member (a first sealing member) that covers the discharge opening 71b to prevent the toner in the developing-side accommodating unit 53a from flowing into the toner accommodating unit 71a. It is further desirable for the developing unit 50 to have a sealing member (a second sealing member) that covers the receiving opening 53b. Additionally, it is desirable that, when the toner cartridge 70 is not mounted in the developing unit 50, the discharge opening 71b and the receiving opening 53b be covered by the sealing members to prevent the toner from flowing out from the discharge opening 71b and the receiving opening 53b, respectively.

### 3. Toner Replenishment Operation

In the present embodiment, of the orientations of the rotary body 90 that rotates as described above, the orientation of the rotary body 90 in which the developing unit 50 is replenished with toner from the toner cartridge 70 is called a “replenishment orientation”. The replenishment orientation is the orientation of the rotary body 90 when the toner cartridge 70 and the developing unit 50 are in positions where the toner within the toner cartridge 70 falls downward due to gravity and moves from the discharge opening 71b into the developing unit 50 through the replenishment opening.

FIG. 2B illustrates an example of the black replenishment orientation for replenishing black toner from the toner cartridge 70k in the present embodiment. In FIG. 2B, it can be seen that the black discharge opening 71b is positioned below the toner cartridge 70k. In this case, due to gravity, the developing unit 50k is replenished with black toner from the toner cartridge 70k. Similarly, for the other colors, when the rotary body 90 rotates and assumes the toner replenishment orientation for the corresponding color (when the toner cartridge 70 of the corresponding color moves to the position of the toner cartridge 70k illustrated in FIG. 2B), the developing unit 50 is replenished with the toner from the toner cartridge 70. The toner with which the developing unit 50k is replenished from the toner cartridge 70k is supplied to the developing roller 51k by the supply roller 52k. Note that if the developing unit 50k is capable of supplying sufficient toner to the developing roller 51k, the developing unit may be configured without the supply roller 52k.

Such control for rotating the rotary body 90 to assume the replenishment orientation for the corresponding color and replenishing the developing unit 50 with the toner of the corresponding color from the toner cartridge 70 will be called “toner replenishment control”. Note that the replenishment orientation of the rotary body 90 is not limited to the position illustrated in FIG. 2B. The replenishment orientation may be any orientation in which the discharge opening 71b is positioned below the toner cartridge 70 and the toner cartridge 70 is in an orientation in which the toner can move from the discharge opening 71b to the developing unit 50 through the replenishment opening due to gravity.

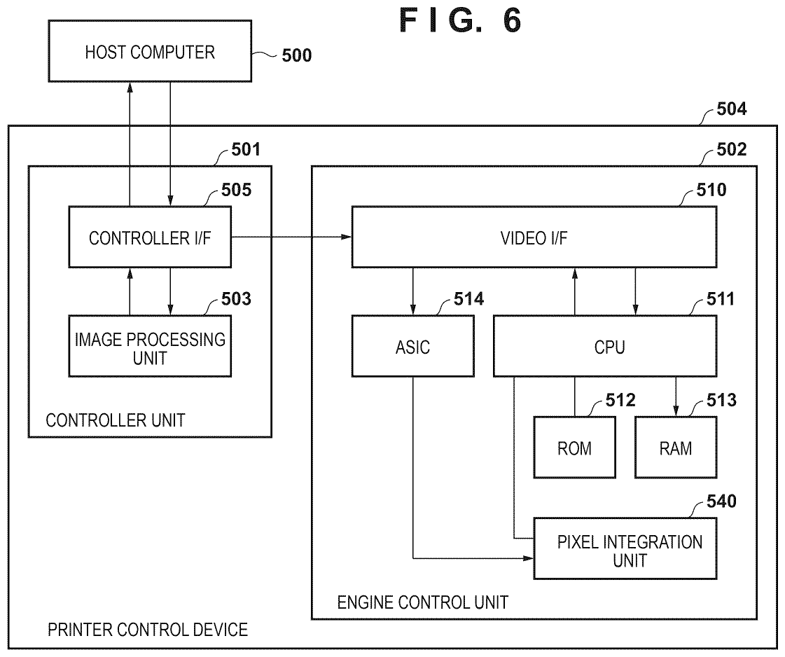

FIG. 5A illustrates an example of the state of the toner on the developing roller 51 immediately after the developing unit 50 has been replenished with toner through the receiving opening 53b. As illustrated in FIG. 5A, immediately after the toner replenishment, much of the toner with which the developing unit 50 has been replenished is in an area centered on a position, on the developing roller 51, that is immediately below the receiving opening 53b.

FIG. 5B illustrates an example of the state after the rotary body 90 has made one rotation from the state illustrated in FIG. 5A. As illustrated in FIG. 5B, rotating the rotary body 90 by a single rotation produces a state where the toner with which the developing unit 50 has been replenished is spread over the entirety of the developing roller 51 in the lengthwise direction. This is because the toner in the developing unit 50 is leveled in the height direction due to gravitational changes arising as the rotary body 90 rotates. Note that as the number of rotations of the rotary body 90 increases, the toner in the developing unit 50 becomes more level due to the gravitational changes, and as the rotation speed of the rotary body 90 increases, the toner becomes more level due to centrifugal force.

### 4. Control Unit

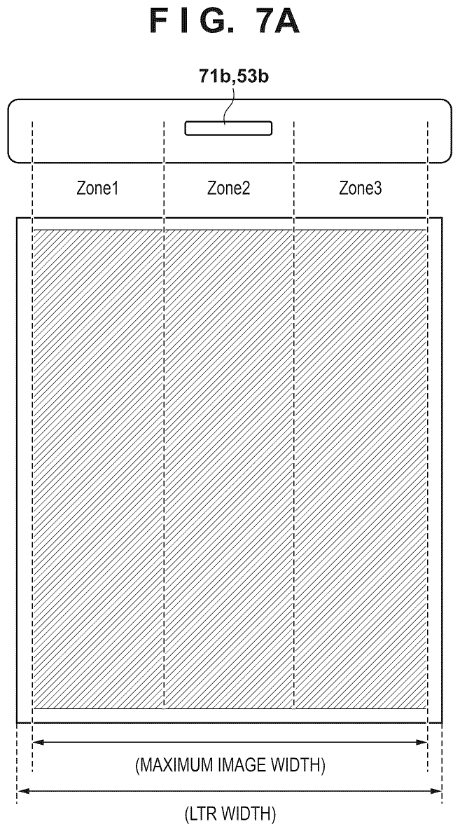

FIG. 6 is a block diagram illustrating an example of the control configuration of the image forming apparatus 1 of the present embodiment. The image forming apparatus 1 includes a printer control device 504. The printer control device 504 connects to and communicates with a host computer 500 using a controller interface (I/F) 505.

The printer control device 504 includes a controller unit 501 and an engine control unit 502. The controller unit 501 includes an image processing unit 503. The controller unit 501 (the controller I/F 505) receives, from the host computer 500, information about instructions made by a user operating the host computer 500. The instructions by the user may include an instruction to execute or cancel printing processing (image formation), an instruction to stop printing processing currently being executed, or the like.

On the basis of image information included in a print job received from the host computer 500, the controller unit 501 performs image processing, such as character code bitmapping processing and grayscale image halftoning processing, using the image processing unit 503. Note that the print job includes information on the number of pixels of the image formed on the recording material. The controller unit 501 sends the post-image processing image information to a video I/F 510 of the engine control unit 502. The image information sent to the engine control unit 502 includes pixel information indicating the pixels included in the input image to be printed. The image information further includes control information for controlling image formation conditions (process conditions), such as transfer bias and fixing temperature, as well as size information indicating the size of the input image.

The engine control unit 502 includes the video I/F 510, a CPU 511, a ROM 512, a RAM 513, an application-specific integrated circuit (ASIC) 514, and a pixel integration unit 540. The pixel information included in the image information received from the controller unit 501 through the video I/F 510 is sent to the ASIC 514. The ASIC 514 counts the pixels to be printed (in each area) in the input image on the basis of the input pixel information, and outputs the obtained pixel count value to the pixel integration unit 540.

The pixel integration unit 540 obtains an integrated value (a pixel count integrated value) S by integrating the pixel count value for each of predetermined areas in the print job on the basis of the pixel count value input from the ASIC 514. The predetermined area corresponds to an area obtained by dividing an image formation area (an area having the maximum image width that can be formed) into a plurality of areas in a width direction orthogonal to a conveyance direction in which the sheets are conveyed. The plurality of areas includes a first area and a second area, which are parts of the image formation area of the recording material and are obtained through division in the direction of the axis of rotation of the developing roller 51. In the present embodiment, the ASIC 514 and the pixel integration unit 540 function as an example of a pixel number determination unit configured to determine, on the basis of information on the number of pixels in the image to be formed on the recording material, a number of pixels in both a first area and a second area, each being a part of an image formation area of the recording material and being obtained by dividing the image formation area in the direction of the axis of rotation.

The control information and the image size information included in the image information received from the controller unit 501 through the video I/F 510 are sent to the CPU 511. The CPU 511 controls the image formation operations by reading out and executing programs stored in the ROM 512 or the RAM 513. The CPU 511 uses the RAM 513 as a work area as necessary. The CPU 511 sets the image formation area, controls a process speed, performs developing control, charging control, and transfer control, and the like, for example. In the present embodiment, the CPU 511 functions as an example of an image formation control unit configured to receive a print job including the information on the number of pixels in the image to be formed on the recording material and execute image formation operations on the basis of the print job.

As described above, when the print job received from the host computer 500 instructs image formation to be performed on a plurality of sheets in the color mode, the image forming apparatus 1 of the present embodiment rotates the rotary body 90 for each instance of image formation on a single sheet. On the other hand, when image formation onto a plurality of sheets is instructed in the monochromatic mode, the images are formed on the plurality of sheets with the rotary body 90 being kept in the black developing orientation without being rotated.

### 5. Calculating Pixel Count Integrated Value

Processing by which the pixel integration unit 540 obtains (calculates) the pixel count integrated value (“integrated value” hereinafter) S will be described next. In the image forming apparatus 1 of the present embodiment, when the execution of a print job is started, the ASIC 514 performs processing for counting the pixels included in the input image on one page on the basis of the input pixel information and obtaining a pixel count value. Specifically, the ASIC 514 counts the pixels to be printed on the basis of the image information (image data) input from the host computer 500. The “pixels to be printed” correspond to the pixels to be developed using toner (the pixels included in an area to which toner will adhere in the electrostatic latent image formed on the photosensitive drum 2).

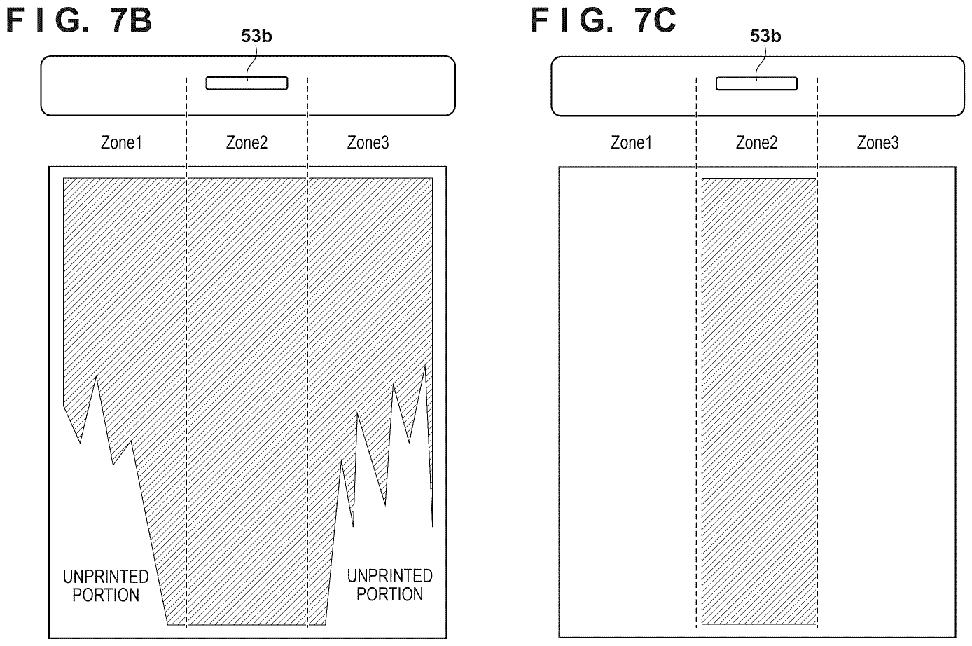

FIG. 7A illustrates an example of a method for dividing an image area (an image formation area) in the present embodiment. In the image forming apparatus 1 of the present embodiment, the maximum sheet width for sheets that can be used in image formation is 215.9 mm, i.e., LTR size, and in this case, the maximum width of the image formation area (maximum image width) is 206 mm. FIG. 7A illustrates an example of the division of the image area when printing an LTR size image (215.9 mm×279 mm).

In the example in FIG. 7A, the image area of the maximum image width is divided into three equal areas (divided areas), namely Zones 1 to 3, in the width direction orthogonal to the sheet conveyance direction. Of these three areas, Zone 2 includes the position of the replenishment opening, which is the communication position at which the discharge opening 71b of the toner cartridge 70 and the receiving opening 53b of the developing unit 50 communicate. The ASIC 514 counts the pixels to be printed in each divided area (zone) on the basis of the image information (image data) corresponding to the input image for a single page, and outputs the pixel count value indicating the number of pixels to be printed.

When forming images consecutively on a plurality of sheets in a single print job, the pixel integration unit 540 performs processing for integrating the pixel count values of the pages for each divided area (zone) to obtain the integrated value S. When the execution of the print job is completed, the pixel integration unit 540 resets the integrated value S to 0, and performs processing for integrating the pixel count values newly input from the ASIC 514 when the next print job is executed.

In the present embodiment, the integrated value S can be stored in the pixel integration unit 540 as a value obtained by multiplying the pixel count values output from the ASIC 514 by a predetermined coefficient (e.g., 1/100000) and then integrating the obtained values. Multiplying the pixel count values by a predetermined coefficient in this manner makes it possible to reduce the unit of the integrated values stored in the pixel integration unit 540, reduces the amount of memory used to store the integrated values, and shortens the processing time.

The resolution of images formed by the image forming apparatus 1 is assumed to be 600 dpi in the present embodiment. In this case, when printing a high printing rate image, in which, for example, toner is caused to adhere to the entire image formation area on an LTR-sized sheet, the maximum pixel count value per page in each divided area (zone) will be approximately 104. As such, when printing solid black images on a plurality of sheets consecutively, a pixel count value of 104 dots per page will be integrated as the integrated value S.

In this manner, in a single print job in which an image is formed on the recording material on the basis of the image information, the pixel integration unit 540 integrates the numbers of pixels, among the pixels included in the input image corresponding to that image information, that are developed by the toner, for each of areas that are different in the width direction of the sheet. Through this, the pixel integration unit 540 obtains and stores the integrated value S. The integrated value S is used by the CPU 511 for toner replenishment control.

### 6. Toner Replenishment Control

Toner replenishment control performed by the image forming apparatus 1 of the present embodiment will be described next. In the image forming apparatus 1, when, for example, printing (forming) images on a plurality of sheets consecutively in the monochromatic mode, images including blank patches may arise in the printed images. FIG. 7B illustrates an example of an image including blank patches, arising when a black high printing rate image (a solid black image, in this example) is printed consecutively in the monochromatic mode. In this example, when a solid black image is formed consecutively over Zones 1 to 3, images including blank patches arise in Zones 1 and 3 before Zone 2. This is because Zone 2 is an area where the toner is replenished through the receiving opening 53b, whereas Zones 1 and 3 are further away from the receiving opening 53b and are therefore less likely to be supplied with the toner replenished through the receiving opening 53b than Zone 2. Such images including blank patches arise, for example, due to insufficient toner supply to the developing roller 51 and the supply roller 52 when the integrated value S in Zones 1 and 3 exceeds a predetermined value.

Accordingly, the image forming apparatus 1 (CPU 511) of the present embodiment controls the operations for replenishing the developing unit 50 with the toner from the toner cartridge 70 on the basis of the integrated value S obtained by the pixel integration unit 540. Specifically, the image forming apparatus 1 sets a threshold for the integrated value S (an integration threshold) for each of the different areas (zones) obtained by dividing the image area in the width direction of the sheet, and executes a toner replenishment operation when the integrated value S exceeds the threshold in a single print job. In the present embodiment, the toner replenishment operation includes, for example, an operation of rotating the rotary body 90 by one rotation. As described above, the developing unit 50 is replenished with toner from the toner cartridge 70 through the receiving opening 53b when the rotary body 90 rotates.

In this manner, in the present embodiment, the CPU 511 functions as an example of a replenishment operation determination unit configured to determine to perform a replenishment operation when a predetermined condition is satisfied, the replenishment operation being an operation of supplying the developing agent (toner) from the developing agent accommodating unit (the toner cartridge 70) to the developing roller accommodating unit (the developing unit 50). When the number of pixels in the first area determined by the pixel number determination unit (the ASIC 514 and the pixel integration unit 540) is taken as a first number of pixels and the number of pixels in the second area determined by the pixel number determination unit is taken as a second number of pixels, the predetermined condition is at least one of that the first number of pixels is greater than a first threshold or that the second number of pixels is greater than a second threshold different from the first threshold. In the present embodiment, each of the first number of pixels and the second number of pixels is an integrated value S of numbers of pixels on a plurality of recording materials on which images are formed on the basis of the print job.

Note that the toner replenishment operation may include an operation of rotating the rotary body 90 to assume an orientation in which toner that has fallen within the toner cartridge 70 (within the developing agent accommodating unit) due to gravity can move into the developing unit 50 (the developing roller accommodating unit) through the replenishment opening (the replenishment orientation). For example, the toner replenishment operation may be an operation of rotating the rotary body 90 by one rotation after the rotary body 90 has assumed the replenishment orientation in this manner.

In the image forming apparatus 1 of the present embodiment, the CPU 511 executes the toner replenishment operation when the integrated value S exceeds the integration threshold in any of the divided areas. The following Table 1 shows the integration thresholds set for each of the divided areas (zones).

TABLE 1
Integration threshold for each divided area

| | | Number of consecutive |
|---|---|---|
| | Integration | printable sheets (solid |
| Divided area | threshold | black image) |
| Zone 1 | 600 | 6 |
| Zone 2 | 1000 | 10 |
| Zone 3 | 600 | 6 |

In the example in Table 1, the plurality of divided areas include first areas (Zones 1 and 3) and a second area (Zone 2) closer to the replenishment opening than the first areas in the lengthwise direction of the developing unit 50. The integration threshold for the first areas (Zones 1 and 3) is set to a value lower than the integration threshold for the second area (Zone 2). Setting the integration threshold to a lower value for the first areas (Zones 1 and 3), which are divided areas in which images including blank patches are more likely to arise as indicated in FIG. 7B, makes it possible to perform the toner replenishment operation at an appropriate timing (before images including blank patches arise).

When using the integration thresholds in Table 1, if, for example, a solid black image is printed over the entire image area for a plurality of sheets consecutively, the integrated value S corresponding to Zones 1 and 3 will reach the integration threshold upon printing the sixth sheet. As a result, the CPU 511 executes the toner replenishment operation (the operation of rotating the rotary body 90 by one rotation) in order to prevent the occurrence of blank patches in the image. Specifically, the CPU 511 performs rotation control for rotating the rotary body 90 by one rotation after the image formation on the sixth sheet is complete and before the image formation on the seventh sheet is started. The execution of the print job is then continued by starting the image formation on the seventh sheet.

When printing a solid black image, pixels are formed (printed) at a uniform printing rate in each divided area (Zones 1 to 3). In this case, in the foregoing example, in Zones 1 and 3 (where the same integration threshold is set, as indicated in Table 1), the integrated value S will reach the integration threshold when forming images on the same number of sheets. However, when forming images at different printing rates for each of the divided areas, the CPU 511 executes the toner replenishment operation when the integrated value S reaches the integration threshold in any of the divided areas. For example, as indicated in FIG. 7C, when printing a solid black image (an image at a printing rate of 100%) consecutively on a plurality of sheets for Zone 2 only, the CPU 511 executes the toner replenishment operation in response to the integrated value S corresponding to Zone 2 reaching the integration threshold when forming an image on the tenth sheet. The CPU 511 resets the integrated value S held by the pixel integration unit 540 to 0 each time the toner replenishment operation (the operation of rotating the rotary body 90 by one rotation) is performed in this manner.

### 7. Processing Sequence

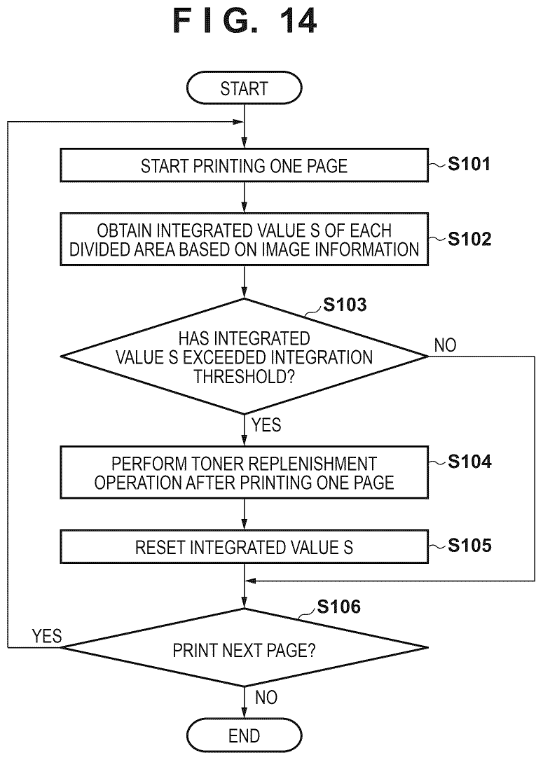

FIG. 14 is a flowchart illustrating an example of a processing sequence for toner replenishment control executed in the image forming apparatus 1 of the present embodiment. The processing of the sequence in FIG. 14 is executed by the CPU 511 (the engine control unit 502) in the image forming apparatus 1. When starting the execution of a print job (a single print job for forming an image on a recording material on the basis of image information) received from an external device such as the host computer 500, the CPU 511 starts the processing of the sequence in FIG. 14.

In step S101, the CPU 511 starts printing the input image for a single page on the basis of the image information of the page to be printed. Once the CPU 511 starts printing the input image for a single page, the sequence moves to step S102. In step S102, using the pixel integration unit 540, the CPU 511 integrates the number of pixels, among the pixels included in the input image corresponding to the image information of the page to be printed, that are to be developed by toner, for each of the areas that are different in the width direction of the sheet (the lengthwise direction of the developing unit 50) (that is, the divided areas). The integrated value S for each divided area is obtained as a result.

When the integrated value S is obtained, in step S103, the CPU 511 determines whether the integrated value S is greater than the integration threshold for any of the divided areas. If the integrated value S is not greater than the integration threshold for any of the divided areas, the CPU 511 moves the sequence to step S106. On the other hand, in step S103, if the integrated value S is greater than the integration threshold for any divided area, the CPU 511 moves the sequence to step S104. For example, the CPU 511 moves the sequence to step S104 when at least one condition among (i) the integrated value S for the first area (Zone 1) being greater than the corresponding integration threshold (the first threshold) or (ii) the integrated value S for the second area (Zone 2) being greater than the corresponding integration threshold (the second threshold) is satisfied.

In step S104, the CPU 511 determines to perform the foregoing replenishment operation. Specifically, the CPU 511 executes the toner replenishment operation described above after the printing of the input image on the single page, started in step S101, is complete. Then, in step S105, the CPU 511 resets the integrated value S corresponding to each divided area, held in the pixel integration unit 540, to 0, and moves the sequence to step S106.

In step S106, if a page to be printed remains in the print job, the CPU 511 returns the sequence to step S101, and the printing of the input image for the next page is started. On the other hand, if no pages remain in the print job to be printed, the CPU 511 ends the execution of the print job, and ends the processing of the sequence in FIG. 14. Note that the CPU 511 resets the integrated value S corresponding to each divided area to 0 in response to the execution of the print job being completed.

### 8. Conclusion

As described above, the image forming apparatus 1 of the present embodiment includes the developing agent accommodating unit (the toner cartridge 70) that accommodates a developing agent, and the developing roller accommodating unit (the developing unit 50) including a developing roller that develops an electrostatic latent image formed on a photosensitive member (photosensitive drum 2) and that has an opening of a length smaller than the length of the developing roller in the direction of the axis of rotation of the developing roller. The developing roller accommodating unit accommodates the developing agent supplied through the opening from the developing agent accommodating unit (the toner cartridge 70). The image formation control unit (the CPU 511) receives a print job including information on a number of pixels in an image to be formed on a recording material and executes an image formation operation on the basis of the print job. The replenishment operation determination unit (the CPU 511) determines to perform the replenishment operation when a predetermined condition is satisfied, the replenishment operation being an operation of supplying the developing agent from the developing agent accommodating unit (the toner cartridge 70) to the developing roller accommodating unit (the developing unit 50). The pixel number determination unit (the ASIC 514 and the pixel integration unit 540) determines, on the basis of the information included in the print job, a number of pixels in both a first area and a second area, each being a part of an image formation area of the recording material and being obtained by dividing the image formation area in the direction of the axis of rotation of the developing roller. When the number of pixels in the first area determined by the pixel number determination unit is taken as a first number of pixels and the number of pixels in the second area determined by the pixel number determination unit is taken as a second number of pixels, the predetermined condition is at least one of that the first number of pixels is greater than a first threshold or that the second number of pixels is greater than a second threshold different from the first threshold.

According to the present embodiment, if the replenishment opening is provided in a partial area in the lengthwise direction of the developing container (the developing roller accommodating unit), the occurrence of blank patches in images can be reduced. In particular, the occurrence of blank patches in images can be reduced when printing high printing rate images consecutively on a plurality of sheets (recording materials). Setting the integration threshold for the integrated value S for each of the different areas in the lengthwise direction of the developing container makes it possible to change the timing at which the toner replenishment operation is executed in accordance with the input image to be formed. This makes it possible to delay the timing of the toner replenishment operation when, for example, a high printing rate image is formed only in an area near the replenishment opening, which makes it possible to reduce unnecessary downtime.

Although the present embodiment describes an example in which the image area in the lengthwise direction (the width direction) is divided into a plurality of areas of equal size, the method for dividing the image area is not limited thereto. For example, the size of each divided area (zone) may be set in accordance with the size of the replenishment opening (the receiving opening 53b) in the developing unit 50, and the integration threshold may be set in accordance therewith. The replenishment opening (the receiving opening 53b) in the developing unit 50 is not limited to the central position in the lengthwise direction as in the foregoing example, and may be provided in another position, and the integration threshold may be set in accordance therewith. For example, the integration threshold is set to a lower value as the distance of the corresponding divided area among the plurality of divided areas from the replenishment opening (the receiving opening 53b) in the width direction (the first direction) of the sheet increases. Additionally, the toner replenishment operation is not limited to an operation of rotating the rotary body 90 by one rotation, and the toner replenishment operation may be implemented by, for example, an operation of increasing the number of rotations of the rotary body 90 or an operation of changing the rotation speed.

### Second Embodiment

A second embodiment will describe an example in which the developing unit 50 has a plurality of openings (receiving openings) for supplying the toner from the toner cartridge 70 (the developing agent accommodating unit). The following will describe areas that are different from the first embodiment.

### 1. Image Forming Apparatus

The configuration and operations of the image forming apparatus 1 of the present embodiment are the same as those of the image forming apparatus 1 of the first embodiment. However, the replenishment opening at the communication position where the discharge opening 71b of the toner cartridge 70 and the receiving opening 53b of the developing unit 50 communicate is provided in two locations in the lengthwise direction of the developing unit 50 (the width direction orthogonal to the conveyance direction of the sheet).

### 2. Toner Cartridge and Developing Unit

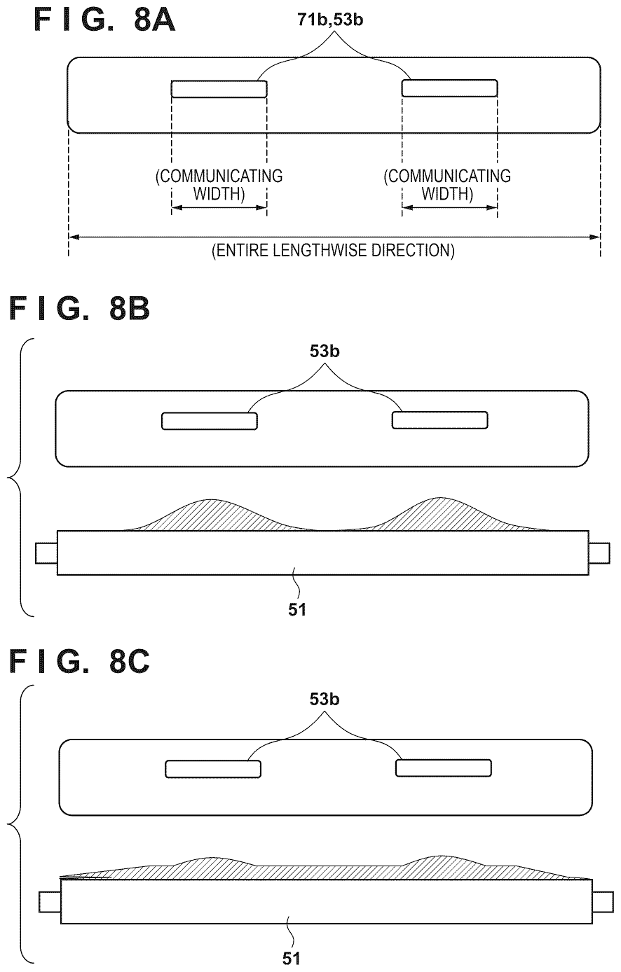

FIG. 8A illustrates an example of the arrangement of the replenishment openings, which are in a communication position where the discharge openings 71b of the toner cartridge 70 and the receiving openings 53b of the developing unit 50 communicate, and is an example of the arrangement with respect to the developing frame 53 (the developing unit 50) when viewed from above. As illustrated in FIG. 8A, in the present embodiment, the two replenishment openings are provided at two positions, respectively, that are substantially symmetrical with respect to the center of the developing unit 50 in the lengthwise direction. Additionally, the width of each replenishment opening in the lengthwise direction (the width direction) is smaller than the width of the replenishment opening provided in the image forming apparatus 1 of the first embodiment. This is to reduce the amount of toner with which the developing unit 50 is replenished from the toner cartridge 70 through the replenishment opening in a single toner replenishment operation. This reduces the amount of time required for the toner to uniformly spread across the entire area in the lengthwise direction within the developing unit 50 after the toner replenishment, while suppressing toner clogging or leakage.

### 3. Toner Replenishment Operation

In the image forming apparatus 1 of the present embodiment, the replenishment orientation of the rotary body 90 is the same as in the first embodiment. For example, when the replenishment orientation illustrated in FIG. 2B is assumed, the developing unit 50k is replenished with black toner from the toner cartridge 70k.

FIG. 8B illustrates an example of the state of the toner on the developing roller 51 immediately after the developing unit 50 has been replenished with toner through the receiving opening 53b. As illustrated in FIG. 8B, immediately after the toner replenishment, much of the toner with which the developing unit 50 has been replenished is in an area centered on positions, on the developing roller 51, that are immediately below the two receiving openings 53b.

FIG. 8C illustrates an example of the state after the rotary body 90 has made one rotation from the state illustrated in FIG. 8B. As illustrated in FIG. 8C, rotating the rotary body 90 by a single rotation produces a state where the toner with which the developing unit 50 has been replenished is spread over the entirety of the developing roller 51 in the lengthwise direction. In the present embodiment, providing two replenishment openings ensures that more toner uniformly spreads over the entirety of the developing roller 51 in the lengthwise direction when the rotary body 90 is rotated by a single rotation.

### 4. Control Unit

The control configuration of the image forming apparatus 1 of the present embodiment is the same as the control configuration of the image forming apparatus 1 of the first embodiment (FIG. 6).

### 5. Calculating Pixel Count Integrated Value

Processing by which the pixel integration unit 540 obtains (calculates) the integrated value S according to the present embodiment will be described. As in the first embodiment, when the execution of a print job is started, the ASIC 514 performs processing for counting the pixels included in the input image on one page on the basis of the input pixel information and obtaining a pixel count value.

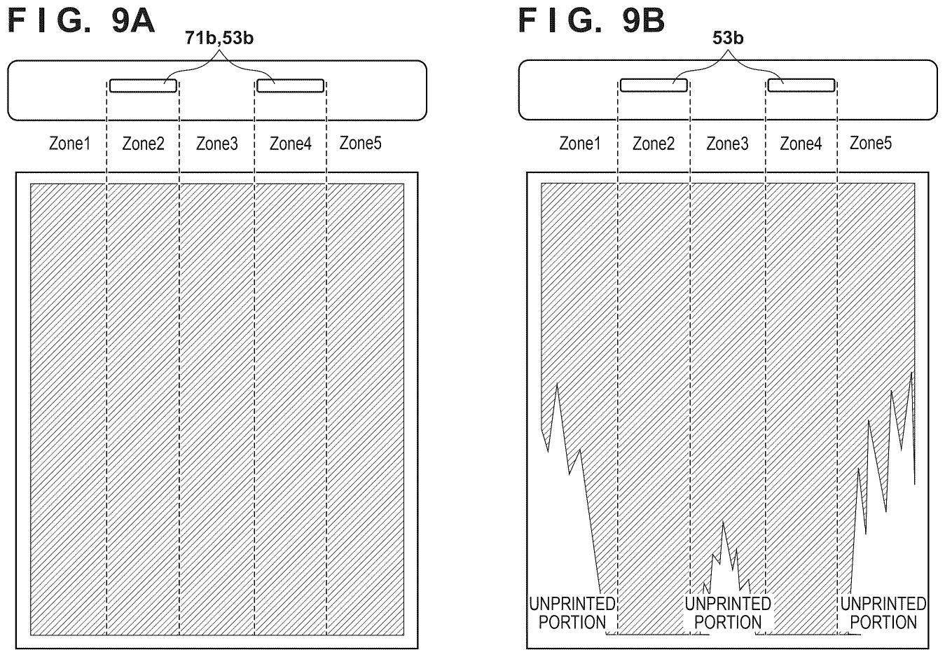

FIG. 9A illustrates an example of a method for dividing an image area (an image formation area) in the present embodiment. In the example in FIG. 9A, the image area of the maximum image width is divided into five equal areas (divided areas), namely Zones 1 to 5, in the width direction orthogonal to the sheet conveyance direction. Of these five areas, Zones 2 and 4 include the positions of the replenishment openings, which is the communication position at which the discharge openings 71b of the toner cartridge 70 and the receiving openings 53b of the developing unit 50 communicate. As in the first embodiment, the ASIC 514 counts the pixels to be printed in each divided area (zone) on the basis of the image information (image data) corresponding to the input image for a single page, and outputs the pixel count value indicating the number of pixels to be printed.

As in the first embodiment, when forming images consecutively on a plurality of sheets in a single print job, the pixel integration unit 540 performs processing for integrating the pixel count values of the pages for each divided area (zone) to obtain the integrated value S. As in the first embodiment, the integrated value S can be stored in the pixel integration unit 540 as a value obtained by multiplying the pixel count values output from the ASIC 514 by a predetermined coefficient (e.g., 1/100000) and then integrating the obtained values.

The resolution of images formed by the image forming apparatus 1 is assumed to be 600 dpi in the present embodiment. In this case, when printing a high printing rate image, in which, for example, toner is caused to adhere to the entire image formation area on an LTR-sized sheet, the maximum pixel count value per page in each divided area (zone) will be approximately 62. As such, when printing solid black images on a plurality of sheets consecutively, a pixel count value of 62 dots per page will be integrated as the integrated value S.

### 6. Toner Replenishment Control

The toner replenishment control of the image forming apparatus 1 of the present embodiment is the same as in the first embodiment. FIG. 9B illustrates an example of an image including blank patches, arising when a black high printing rate image (a solid black image, in this example) is printed consecutively in the monochromatic mode. In this example, when a solid black image is formed consecutively over Zones 1 to 5, images including blank patches arise in Zones 1, 3, and 5 before Zones 2 and 4. This is because Zones 2 and 4 are areas where the toner is replenished through the receiving openings 53b, whereas Zones 1, 3 and 5 are further away from the receiving openings 53b and are therefore less likely than Zones 2 and 4 to be supplied with the toner replenished through the receiving openings 53b. Such images including blank patches arise, for example, due to insufficient toner supply to the developing roller 51 and the supply roller 52 when the integrated value S in Zones 1, 3, and 5 exceeds a predetermined value.

As in the first embodiment, the CPU 511 executes the toner replenishment operation when the integrated value S exceeds the integration threshold in any of the divided areas. The following Table 2 shows the integration thresholds set for each of the divided areas (zones).

TABLE 2
Integration threshold for each divided area

| | | Number of consecutive |
|---|---|---|
| | Integration | printable sheets (solid |
| Divided area | threshold | black image) |
| Zone 1 | 380 | 7 |
| Zone 2 | 500 | 9 |
| Zone 3 | 440 | 8 |
| Zone 4 | 500 | 9 |
| Zone 5 | 380 | 7 |

When using the integration thresholds in Table 2, if, for example, a solid black image is printed over the entire image area for a plurality of sheets consecutively, the integrated value S corresponding to Zones 1 and 5 will reach the integration threshold upon printing the seventh sheet. As a result, the CPU 511 executes the toner replenishment operation (the operation of rotating the rotary body 90 by one rotation) in order to reduce the occurrence of blank patches in the image. Specifically, the CPU 511 performs rotation control for rotating the rotary body 90 by one rotation after the image formation on the seventh sheet is complete and before the image formation on the eighth sheet is started. The execution of the print job is then continued by starting the image formation on the eighth sheet.

In the foregoing example, the reason why the number of sheets on which a solid black image can be printed consecutively is greater than in the example described using Table 1 in the first embodiment is that the increase in the number of replenishment openings makes it easier for the toner with which the developing unit 50 is replenished to spread over the entirety of the developing roller 51 in the lengthwise direction. In addition, for Zone 3, the number of sheets on which solid black images can be printed consecutively is greater than in Zones 1 and 5. This is because Zone 3 is the area between Zones 2 and 4, which correspond to the two replenishment openings, and the amount of toner replenished through the two replenishment openings and supplied to Zone 3 is greater than the amount of toner supplied to Zones 1 and 5.

In the present embodiment, the width of each replenishment opening is smaller than in the first embodiment, as described above. As a result, although the number of sheets on which a solid black image can be printed consecutively for Zones 2 and 4 corresponding to the two replenishment openings is lower than in the first embodiment, the increase in the number of divisions in the image area enables more accurate toner replenishment control according to the pattern of the input image.

### 7. Processing Sequence

An example of a processing sequence for toner replenishment control executed in the image forming apparatus 1 of the present embodiment is the same as in the first embodiment. When the CPU 511 starts executing a print job received from an external device such as the host computer 500, the processing of the sequence in FIG. 14 is performed in the same manner as in the first embodiment.

### 8. Conclusion

As described above, according to the present embodiment, the developing unit 50 is provided with a plurality of openings (receiving openings) for supplying toner from the toner cartridge 70 (the toner container). This makes it possible to reduce the occurrence of blank patches in images in the same manner as in the first embodiment, and to increase the number of sheets on which high printing rate images can be printed consecutively.

Although the present embodiment describes an example in which the image area in the lengthwise direction (the width direction) is divided into a plurality of equal areas, the method for dividing the image area is not limited thereto. For example, the size of each divided area (zone) may be set in accordance with the size of the replenishment opening (the receiving opening 53b) in the developing unit 50, and the integration threshold may be set in accordance therewith. The two replenishment openings (the receiving openings 53b) in the developing unit 50 are not limited to being symmetrical relative to the central position in the lengthwise direction as in the foregoing example, and may be provided in another position, and the integration threshold may be set in accordance therewith. Furthermore, although two replenishment openings are provided as the plurality of replenishment openings (receiving openings) in the present embodiment, three or more replenishment openings may be provided.

### Third Embodiment

A third embodiment will describe an example of the application of the toner replenishment control described above to an image forming apparatus having a different configuration from the first and second embodiments as a variation on the first and second embodiments. The following will describe areas that are different from the first embodiment.

### 1. Image Forming Apparatus

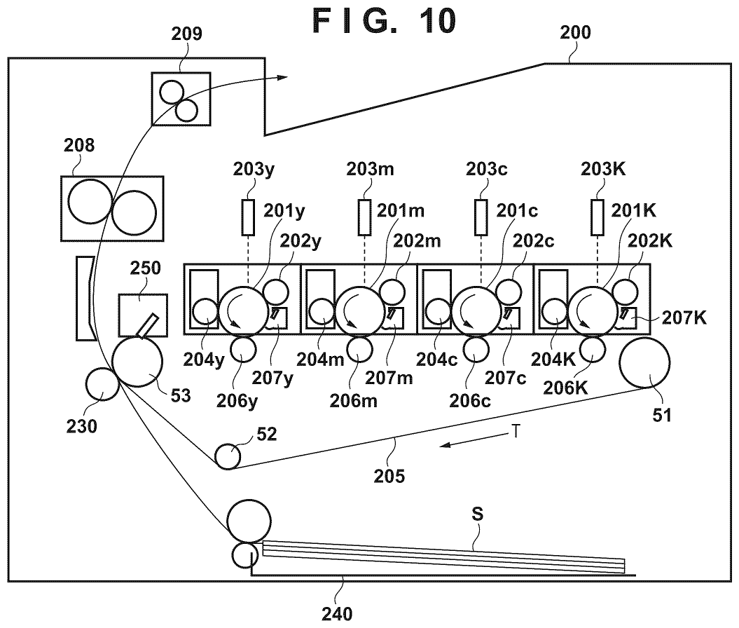

FIG. 10 is a cross-sectional view schematically illustrating an example of the hardware configuration of an image forming apparatus 200 according to the present embodiment. The image forming apparatus 200 is an in-line image forming apparatus that includes four image forming units that form images using four different colors of toner (yellow, magenta, cyan, and black). The basic structures and functions of the image forming units are the same. Accordingly, when there is no need to distinguish between the four image forming units, the subscripts y, m, c, and k will be omitted to indicate the component constituting any one of the four image forming units.

Each image forming unit includes an electrophotographic photosensitive member (“photosensitive drum”, hereinafter) 201 (201y, 201m, 201c, 201k) having a drum shape (a cylindrical shape) as an image carrier that carries an electrostatic latent image. A charger 202 (202y, 202m, 202c, 202k), a scanner 203 (203y, 203m, 203c, 203k), a developing device 204 (204y, 204m, 204c, 204k), a transfer roller 206 (206y, 206m, 206c, 206k), and a cleaning unit 207 (207y, 207m, 207c, 207k) are provided in the periphery of the photosensitive drum 201. The scanner 203 is disposed above the photosensitive drum 201. The image forming units have the same configuration, and will hereinafter be collectively referred to as an image forming unit P.

An image forming sequence (an image forming process) performed by the image forming apparatus 200 will be described here. First, the charger 202 uniformly charges the photosensitive drum 201. The scanner 203 performs exposure by irradiating the photosensitive drum 201 with laser light based on image information (input image data). An electrostatic latent image is formed on the surface of the photosensitive drum 201 by irradiating the charged photosensitive drum 201 with laser light from the scanner 203. After the electrostatic latent image is formed, the electrostatic latent image is developed using toner of a corresponding color by the developing device 204 at a developing position. Executing such a process in each image forming unit results in yellow, magenta, cyan, and black toner images being formed on the photosensitive drums 201y, 201m, 201c, and 201k, respectively.

The image forming apparatus 200 further includes an intermediate transfer belt (intermediate transfer body) 205 disposed below each image forming unit. The intermediate transfer belt 205 is stretched over rollers 51, 52, and 53, and is moved in the direction of an arrow T. The toner image on each photosensitive drum 201 is transferred (a primary transfer) by a corresponding transfer roller 206 so as to be superimposed on the intermediate transfer belt 205 in order. A color image (a multicolor image) in which four toner images of yellow, magenta, cyan, and black are superimposed is formed on the intermediate transfer belt 205 as a result. The cleaning unit 207 removes (collects) toner remaining on the surface of the photosensitive drum 201 after the primary transfer to the intermediate transfer belt 205.

At the secondary transfer part, the color image on the intermediate transfer belt 205 is transferred onto the surface of the sheet S, which has been conveyed from a sheet accommodating unit 240 through the conveyance path, at a secondary transfer part (a secondary transfer). Toner remaining on the intermediate transfer belt 205 after the secondary transfer to the sheet S is removed (collected) by a cleaning unit 250. The sheet S onto which the color image has been transferred is conveyed to a fixing device 208. In the fixing device 208, the sheet S is heated and pressurized, and the image is fixed to the sheet S. The sheet S that has passed through the fixing device 208 is discharged to the exterior of the image forming apparatus 200 as a finished product.

### 2. Toner Cartridge and Developing Unit

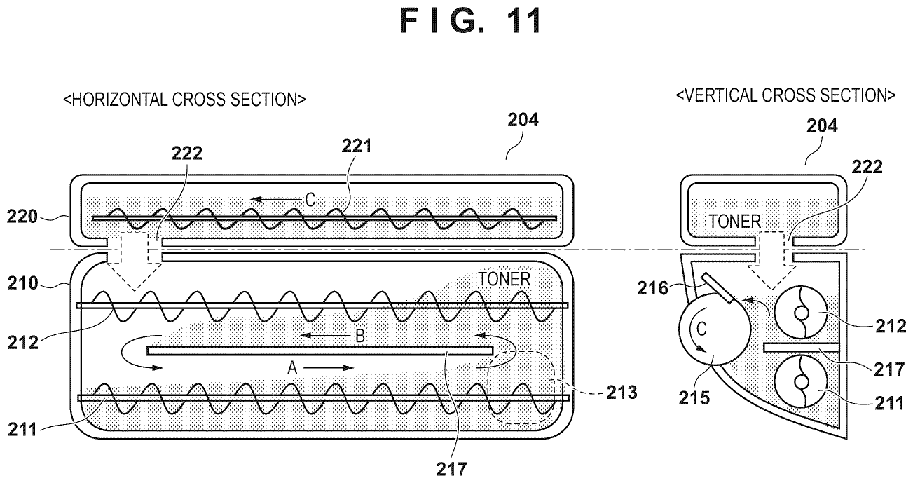

FIG. 11 is a cross-sectional view illustrating an example of the configuration of the developing device 204 of the image forming apparatus 200 of the present embodiment. The developing device 204 includes a toner container 220 and a developing container 210. The toner container 220 (the developing agent accommodating unit) is attachable to and detachable from the image forming apparatus 200, and accommodates toner (a developing agent) for replenishing the developing container 210. The toner container 220 includes a rotatable conveyance screw 221 (a screw member) that conveys the toner to replenish the toner in the developing container 210.

The conveyance screw 221 conveys the toner in the direction of an arrow C, toward a replenishment opening 222 in the toner container 220, by rotating. The developing container 210 is replenished (supplied) with the toner conveyed by the conveyance screw 221 in the toner container 220 through the replenishment opening 222 provided in a partial area of the lengthwise direction of the toner container 220 (the width direction orthogonal to the sheet conveyance direction). In this manner, the conveyance screw 221 is an example of a screw member capable of rotating, the screw member conveying the toner within the toner container 220 to replenish the developing container 210 through the replenishment opening 222.

The developing container 210 (the developing roller accommodating unit) includes a developing roller 215 and a regulating blade 216 therein. The developing roller 215 is a developing agent carrier (developing member) that carries toner as a developing agent, rotates, and supplies the toner to the corresponding photosensitive drum 201. The interior of the developing container 210 is divided into two developing chambers in the vertical direction by a partition 217, which is disposed in approximately the center of the developing container 210 and extends in the direction perpendicular to the surface of the sheet S being conveyed. Conveyance screws 211 and 212 are disposed in the upper and lower developing chambers, respectively. The conveyance screws 211 and 212 are arranged parallel to the axis of rotation of the developing roller 215.

The toner replenished from the toner container 220 through the replenishment opening 222 falls within the developing container 210 due to gravity, and is conveyed in the direction of an arrow A in the lower developing chamber as the conveyance screw 211 rotates. The conveyed toner is pushed upward at a push-up area 213 into the upper developing chamber, and is conveyed in the direction of an arrow B in the upper developing chamber as the conveyance screw 212 rotates. In this manner, by being conveyed as a result of the conveyance screws 211 and 212 rotating, the toner is circulated between the upper developing chamber and the lower developing chamber through openings provided at both ends of the partition 217 in the lengthwise direction. In the developing container 210, toner is supplied to the developing roller 215 by the conveyance screw 212 in the upper developing chamber. The developing roller 215 carries the toner having a layer thickness regulated by the regulating blade 216.

The image forming apparatus 200 of the present embodiment has a configuration in which the conveyance screw 221 in the toner container 220 is driven by a drive motor (a drive source) different from the drive motor (drive source) that drives the developing roller 215. This configuration makes it possible to control the rotation speed of the developing roller 215 and the rotation speed of the conveyance screw 221 independently. For example, the ratio of the rotation speed of the conveyance screw 221 to the rotation speed of the developing roller 215 can be controlled (changed).

The developing container 210 includes an opening provided in a position corresponding to a developing area opposite the photosensitive drum 201. The developing roller 215 is disposed such that the developing roller 215 is capable of rotating with a part thereof being exposed in the direction of the photosensitive drum 201 through the opening provided in the developing container 210. The developing roller 215 rotates in the direction of the arrow C in FIG. 11 (the counterclockwise direction) and supplies the carried toner to the electrostatic latent image formed on the photosensitive drum 201 to develop the electrostatic latent image. A toner image is formed on the photosensitive drum 201 as a result.

### 3. Toner Replenishment Operation

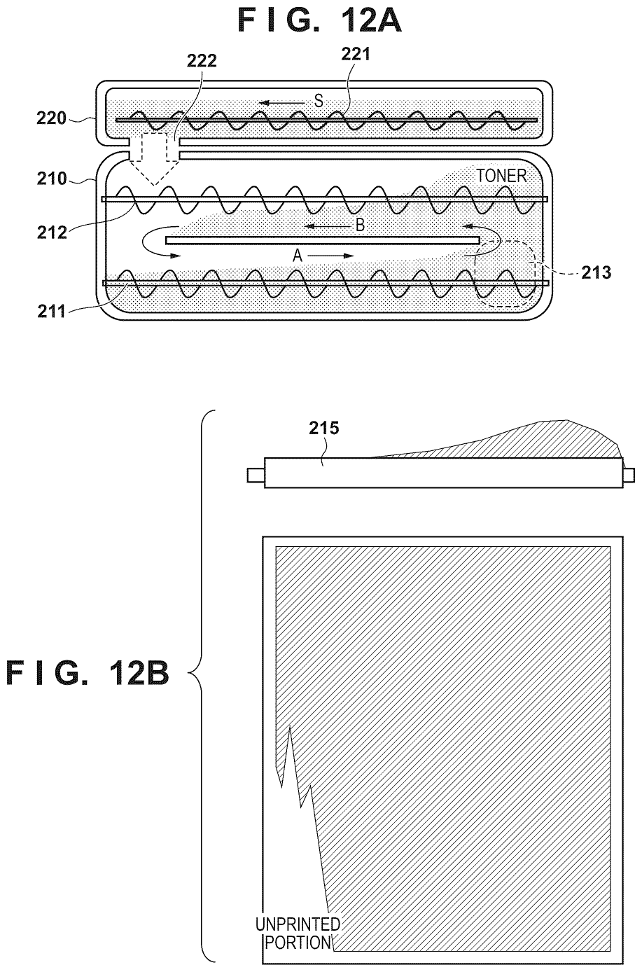

FIG. 12A is a cross-sectional view (a lateral cross-sectional view) illustrating an example of the states of the toner container 220 and the developing container 210 when a black high printing rate image (a solid black image, in this example) is printed consecutively on a plurality of sheets in the monochromatic mode. The toner in the upper developing chamber in the developing container 210 is in a state in which more toner is present on the push-up area 213 side in the lengthwise direction of the developing container 210 than on the other side thereof (the replenishment opening side). This indicates that not enough toner is supplied to the developing roller 215 due to the high amount of toner consumed to develop the high printing rate images. In the upper developing chamber in the developing container 210, the toner is conveyed in the direction of the arrow B. Accordingly, when printing high printing rate images consecutively, not enough toner is supplied on the downstream side in the toner conveyance direction (the replenishment opening side).

FIG. 12B illustrates an example of an image including blank patches, which occurs when solid black images are printed consecutively. As described above, in this example, not enough toner is supplied to the developing roller 215 on the replenishment opening side of the developing container 210. As a result, images with blank patches arise in the area near the developing opening in the lengthwise direction of the developing container 210 (the width direction of the sheet) due to the insufficient toner supply.

In the present embodiment, when printing high printing rate images on a plurality of sheets consecutively in this manner, the rotation speed (number of rotations) of the conveyance screw 221 of the toner container 220 is changed to accelerate the conveyance of the toner to the replenishment opening in the toner container 220. As a result, the amount of toner with which the developing container 210 is replenished from the toner container 220 through the replenishment opening is adjusted to reduce the occurrence of blank patches in the images.

### 4. Control Unit

The control configuration of the image forming apparatus 200 of the present embodiment is the same as the control configuration of the image forming apparatus 1 of the first embodiment (FIG. 6).

### 5. Calculating Pixel Count Integrated Value

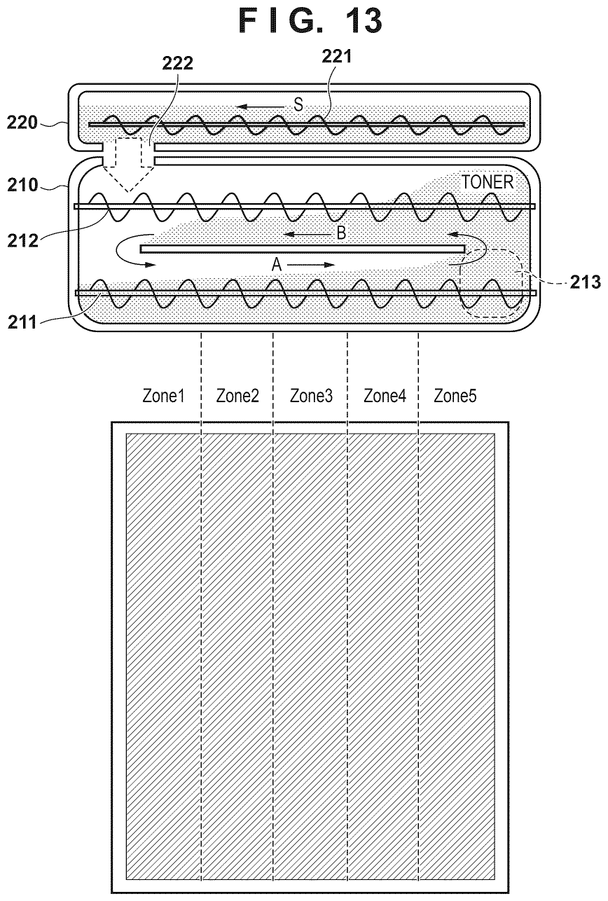

FIG. 13 illustrates an example of dividing the image area of the maximum image width into five equal areas (divided areas), namely Zones 1 to 5, in the width direction orthogonal to the sheet conveyance direction, in the same manner as in the second embodiment (FIGS. 9A and 9B). As in the first embodiment, the ASIC 514 counts the pixels to be printed in each divided area (zone) on the basis of the image information (image data) corresponding to the input image for a single page, and outputs the pixel count value indicating the number of pixels to be printed. As in the first embodiment, when forming images consecutively on a plurality of sheets in a single print job, the pixel integration unit 540 performs processing for integrating the pixel count values of the pages for each divided area (zone) to obtain the integrated value S.

### 6. Toner Replenishment Control

In the image forming apparatus 200 of the present embodiment too, when, for example, printing (forming) images on a plurality of sheets consecutively in the monochromatic mode, images including blank patches may arise in the printed images (downstream in the conveyance direction of the toner by the conveyance screw 212, as indicated in FIG. 13). The image forming apparatus 200 of the present embodiment performs processing for adjusting the amount of toner replenished from the toner container 220 on the basis of the integration threshold for the integrated value S, and the integrated value S, for each of the divided areas (zones) obtained by dividing the image area in the width direction of the sheet in a single print job. The amount of toner replenished is adjusted by changing the number of rotations (the rotation speed) of the conveyance screw 221. The following Table 3 shows the integration thresholds set for each of the divided areas (zones).

TABLE 3
Integration threshold for each divided area

| | Number of rotations of conveyance screw | | |
|---|---|---|---|
| Divided area | 390 rpm (1x) | 507 rpm (1.3x) | 585 rpm (1.5x) |
| Zone 1 | up to 100 | up to 150 | up to 200 |
| Zone 2 | up to 150 | up to 200 | up to 250 |
| Zone 3 | up to 200 | up to 250 | up to 300 |
| Zone 4 | up to 250 | up to 300 | up to 350 |
| Zone 5 | up to 300 | up to 350 | up to 400 |

In the example in Table 3, three integration thresholds are set for each divided area (zone), and the number of rotations of the conveyance screw 221 is set for each integration threshold. For example, for each divided area, the CPU 511 performs control to change the number of rotations of the conveyance screw 221 to a set number of rotations corresponding to the integration threshold (1.3 times or 1.5 times the number of rotations) each time the corresponding integrated value S reaches the integration threshold. As a result, the amount of toner with which the developing container 210 is replenished from the toner container 220 is increased to reduce the occurrence of the stated images including blank patches. Note that the amount of toner replenished may be adjusted by changing the number of rotations (the rotation speed) of the conveyance screw 212 instead of the number of rotations (rotation speed) of the conveyance screw 221.

### 7. Processing Sequence

An example of a processing sequence for toner replenishment control executed in the image forming apparatus 1 of the present embodiment is the same as in the first embodiment. When the CPU 511 starts executing a print job received from an external device such as the host computer 500, the processing of the sequence in FIG. 14 is performed in the same manner as in the first embodiment. However, in the toner replenishment operation of step S104, the CPU 511 replenishes the toner by rotating the conveyance screw 221 (the screw member), or increases the amount of toner replenished by performing an operation that increases the rotation speed of the conveyance screw 221. In addition, the CPU 511 does not perform the processing of step S105 (i.e., does not reset the integrated value S after the completion of the toner replenishment operation). As a result, the CPU 511 increases the amount of toner replenished in stages by performing processing of increasing the rotation speed of the conveyance screw 221 in step S104 each time one of the three integration thresholds indicated in Table 3 is reached for each divided area.

### 8. Conclusion

As described above, according to the present embodiment, controlling the number of rotations (rotation speed) of the conveyance screw 221 makes it possible to control the toner replenishment operations to reduce the occurrence of blank patches in images when high printing rate images are continuously printed.

Although the present embodiment describes an example in which the image area in the lengthwise direction (the width direction) is divided into a plurality of areas of equal size, the method for dividing the image area is not limited thereto. For example, the size of each divided area (zone) may be changed in accordance with the size of the replenishment opening in the developing container 210 (the developing unit), and the integration threshold may be changed (set) in accordance therewith.

According to the present disclosure, the occurrence of images having blank patches can be reduced in an image forming apparatus in which a replenishment opening is provided in a partial area in the lengthwise direction of a developing container (a developing roller accommodating unit).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-194553, filed Nov. 6, 2024, which is hereby incorporated by reference herein in its entirety.

What is claimed is:

1. An image forming apparatus comprising:
a developing agent accommodating unit configured to accommodate a developing agent;
a developing roller accommodating unit including a developing roller that develops an electrostatic latent image formed on a photosensitive member, and having an opening of a length smaller than a length of the developing roller in a direction of an axis of rotation of the developing roller, the developing roller accommodating unit configured to accommodate the developing agent supplied from the developing agent accommodating unit through the opening;
an image formation control unit configured to receive a print job including information on a number of pixels in an image to be formed on a recording material and execute an image formation operation based on the print job;
a replenishment operation determination unit configured to determine to perform a replenishment operation in a case where a predetermined condition is satisfied, the replenishment operation being an operation of supplying the developing agent from the developing agent accommodating unit to the developing roller accommodating unit; and
a pixel number determination unit configured to determine, based on the information, a number of pixels in both a first area and a second area, each being a part of an image formation area of the recording material and being obtained by dividing the image formation area in the direction of the axis of rotation,
wherein in a case where the number of pixels in the first area determined by the pixel number determination unit is taken as a first number of pixels and the number of pixels in the second area determined by the pixel number determination unit is taken as a second number of pixels, the predetermined condition is at least one of that the first number of pixels is greater than a first threshold and that the second number of pixels is greater than a second threshold different from the first threshold.

2. The image forming apparatus according to claim 1,
wherein each of the first number of pixels and the second number of pixels is an integrated value of numbers of pixels on a plurality of recording materials on which images are formed based on the print job.

3. The image forming apparatus according to claim 1,
wherein the second area is an area closer to the opening than the first area in the direction of the axis of rotation, and
the first threshold is set to a value lower than the second threshold.

4. The image forming apparatus according to claim 1,
wherein a threshold is set for each of a plurality of areas obtained by dividing the image formation area in the direction of the axis of rotation, the plurality of areas including the first area and the second area, and
the replenishment operation determination unit determines to perform the replenishment operation in a case where the number of pixels corresponding to at least one area among the plurality of areas exceeds the threshold set for the area.

5. The image forming apparatus according to claim 4,
wherein the threshold is set to a lower value as a distance of the corresponding area, among the plurality of areas, from the opening in the direction of the axis of rotation increases.

6. The image forming apparatus according to claim 4,
wherein a size of each of the plurality of areas is determined according to a size of the opening.

7. The image forming apparatus according to claim 6,
wherein the threshold corresponding to each of the plurality of areas is set in accordance with a size of the corresponding area.

8. The image forming apparatus according to claim 1,
wherein the pixel number determination unit determines, based on the information, a number of pixels to be developed by the developing agent in each of the first area and the second area.

9. The image forming apparatus according to claim 1,
wherein the developing roller accommodating unit has a plurality of openings for supplying the developing agent from the developing agent accommodating unit, and
the developing roller accommodating unit is configured such that a length of each of the openings in the direction of the axis rotation is shorter as a number of the openings provided in the developing roller accommodating unit increases.

10. The image forming apparatus according to claim 1, further comprising:
a rotary that includes the developing roller accommodating unit and to and from which the developing agent accommodating unit can be attached and detached,
wherein the replenishment operation includes an operation of rotating the rotary by one rotation.

11. The image forming apparatus according to claim 10,
wherein the replenishment operation includes an operation of rotating the rotary to assume an orientation in which developing agent that has fallen within the developing agent accommodating unit due to gravity can move into the developing roller accommodating unit through the opening.

12. The image forming apparatus according to claim 11,
wherein the replenishment operation is an operation of rotating the rotary by one rotation after the rotary has assumed the orientation.

13. The image forming apparatus according to claim 1,
wherein the developing agent accommodating unit includes a screw member capable of rotating, the screw member being configured to convey the developing agent within the developing agent accommodating unit to replenish the developing roller accommodating unit with the developing agent through the opening, and
the replenishment operation is an operation of rotating the screw member or increasing a rotation speed of the screw member.

14. The image forming apparatus according to claim 1,
wherein the developing roller accommodating unit includes a screw member capable of rotating, the screw member being configured to convey the developing agent, with which the developing agent accommodating unit has been replenished through the opening, within the developing roller accommodating unit for supply to the developing roller accommodating unit, and
the replenishment operation is an operation of rotating the screw member or increasing a rotation speed of the screw member.

15. The image forming apparatus according to claim 14,
wherein each of the first number of pixels and the second number of pixels is an integrated value of numbers of pixels on a plurality of recording materials on which images are formed based on the print job,
when the integrated value corresponding to the first area reaches the first threshold, the replenishment operation determination unit determines to increase the rotation speed of the screw member, and when the integrated value then reaches a third threshold greater than the first threshold, the replenishment operation determination unit determines to further increase the rotation speed of the screw member, and
when the integrated value corresponding to the second area reaches the second threshold, the replenishment operation determination unit determines to increase the rotation speed of the screw member, and when the integrated value then reaches a fourth threshold greater than the second threshold, the replenishment operation determination unit determines to further increase the rotation speed of the screw member.

16. The image forming apparatus according to claim 2,
wherein in a case where the replenishment operation is performed, the pixel number determination unit resets the integrated value to 0.

17. The image forming apparatus according to claim 2,
wherein in a case where execution of the print job is completed, the pixel number determination unit resets the integrated value to 0.
